(19) United States
(12) Patent Application Publication
(10) Pub. No.: US 2026/0162086 A1
(43) Pub. Date: Jun. 11, 2026

(54) CROSS-DIGITAL ENVIRONMENT VIRTUAL ECONOMY MANAGEMENT

(71) Applicant: Skillz Platform Inc., San Francisco, CA (US)

(72) Inventors: Kristian D. Diakov, Dana Point, CA (US); Thomas Fallon, Las Vegas, NV (US); Tim Napoleon, Las Vegas, NV (US); Brent Hickey, Las Vegas, NV (US); Brook Boese, Portland, OR (US)

(21) Appl. No.: 19/292,450

(22) Filed: Aug. 6, 2025

Related U.S. Application Data
(60) Provisional application No. 63/680,596, filed on Aug. 7, 2024.

(51) Int. Cl. G06Q 20/06; G06F 3/04842; G06Q 30/0204

(52) U.S. Cl. CPC G06Q 20/065; G06F 3/04842; G06Q 30/0204

(57) ABSTRACT

Methods and systems for managing virtual economy across different digital environments are provided. A request to interact with a first interactive software module is received at a first digital environment. The request is associated with a number of first virtual tokens required to interact with the first interactive software module. In response to receiving the request, an instance of the first interactive software module is executed. Based on an outcome determined by the first interactive software module, a number of second virtual tokens are generated. Data indicative of the number of second virtual tokens is transferred to a second digital environment via an abstraction layer, such that the second virtual tokens are usable with one or more second interactive software modules integrated with the second digital environment. At least one event handler is then provided to receive inputs for exchanging second virtual tokens for redeemable objects.

### CROSS-REFERENCE TO RELATED APPLICATIONS

This application claims the benefit under 35 U.S.C. § 119 of U.S. Provisional Application No. 63/680,596 filed on Aug. 7, 2024, entitled “SOCIAL CASINO BASED GAMING SYSTEMS AND METHODS” the entirety of which is hereby incorporated by reference.

### TECHNICAL FIELD

The subject matter described herein relates to digital environments.

### BACKGROUND

With the increasing availability of computing devices and high-speed network connectivity, a wide variety of digital environments have become accessible to users around the world. These environments can provide interactive experiences, social features, and various forms of entertainment, including, for example, games, virtual competitions, online communities, and the like. Many digital environments implement virtual economies, which many times involve the use of digital representations of value, such as points, tokens, credits, or similar virtual items. These virtual items can be allocated to users based on their activity, achievements, or other criteria, and may be used to access additional features, participate in interactive experiences, or obtain digital or physical rewards.

### SUMMARY

This disclosure relates to cross-digital environment virtual economy management.

An example implementation of the subject matter described within this disclosure is a method with the following features. A request to interact with a first interactive software module is received at a first digital environment. The first interactive software module is integrated with the first digital environment. The request is associated with a number of first virtual tokens required to interact with the first interactive software module. In response to receiving the request, an instance of the first interactive software module is executed. Based on an outcome determined by the first interactive software module, a number of second virtual tokens are generated. The second virtual tokens are different from the first virtual tokens. Data indicative of the number of second virtual tokens is transferred to a second digital environment via an abstraction layer, such that the second virtual tokens are usable with one or more second interactive software modules. The abstraction layer is communicatively coupled with the first digital environment and the second digital environment and is configured to integrate one or more second interactive software modules with the second digital environment. At least one event handler is then provided. The at least one event handler is configured to receive inputs for exchanging one or more second virtual tokens for redeemable objects. Each redeemable object is associated with a monetary value.

The disclosed method can be implemented in a variety of ways. For example, within a system that includes at least one data processor and a non-transitory memory storing instructions for the processor to perform aspects of the method. Alternatively or in addition, the method can be included in non-transitory computer readable memory storing the method as instructions which, when executed by at least one data processor forming part of at least one computing system, causes the at least one data processor to perform operations of the method.

Aspects of the example method, that can be combined with the example method alone or in combination with other aspects, can include the following. The first virtual tokens can be stored in a first virtual token container associated with a user while the second virtual tokens can be stored in a second virtual token container associated with the user. The second virtual token container is separated from the first virtual token container. In some implementations, when receiving the request to interact with the first interactive software module, the first virtual token container is updated to reflect a deduction of the number of first virtual tokens required to interact with the first interactive software module. In some implementations, when executing the instance of the first interactive software module, the second virtual token container is updated to reflect a crediting of the number of second virtual tokens to the user based on the outcome determined by the first interactive software module. In some cases, the second virtual tokens can be used to interact with the first interactive software module integrated with the first digital environment.

Aspects of the example method, that can be combined with the example method alone or in combination with other aspects, can include the following. A random number generator can be invoked during the execution of the instance of the first interactive software module. In some implementations, the random number generator can be implemented by the first interactive software module and configured to generate at least one random value used to determine the outcome generated by the first interactive software module.

Aspects of the example method, that can be combined with the example method alone or in combination with other aspects, can include the following. In response to a user-initiated transaction processed by the first digital environment, the first virtual token container and the second virtual token container associated with the user can be respectively updated to increase an amount of the first virtual tokens and an amount of the second virtual tokens stored therein. In some implementations, the user-initiated transaction can be triggered automatically by the first digital environment upon detecting the first digital environment being accessed by the user. In some implementations, the user-initiated transaction can be triggered automatically by the first digital environment upon detecting the amount of the first virtual tokens stored in the first virtual token container associated with the user is below a predetermined threshold.

Aspects of the example method, that can be combined with the example method alone or in combination with other aspects, can include the following. The user-initiated transaction can be triggered by an event corresponding to a limited time availability of increasing the amount of the first virtual tokens and the amount of the second virtual tokens stored in the first virtual token container and the second virtual token container associated with the user. In some implementations, data characterizing user interactions with the first environment can be received. The user can be classified into a user segment selected from multiple user segments based on the user interactions with the first environment. The event corresponds to the limited time availability of increasing the amount of the first virtual tokens and the amount of the second virtual tokens in the first virtual token container and the second virtual token container associated with the user can then be generated. In some cases, the classification can be done via a machine learning model trained to output the user segment for the generation of the event, using the data characterizing the user interactions with the first digital environment as inputs. In some implementations, a token multiplier corresponds to a tier level designated to the user can be determined and the amount of the second virtual tokens to increase can then be calculated based on the determined token multiplier. In some cases, the tier level can be updated upon detecting that the amount of the second virtual tokens stored in the second virtual token container associated with the user during a predetermined time period exceeds a threshold value.

Aspects of the example method, that can be combined with the example method alone or in combination with other aspects, can include the following. One or more additional interactive software modules can be integrated with the first digital environment and/or the second digital environment via the abstraction layer. In some implementations, the abstraction layer is configured to provide a set of provider-specific adapters that implement a plurality of standardized operations for executing one or more instances of the one or more additional interactive software modules in respective digital environments. Accordingly, the one or more additional interactive software modules can be integrated with the first digital environment and/or the second digital environment without requiring modifications of the respective digital environment, and the one or more instances of the one or more additional interactive software modules can be executed via the abstraction layer irrespective of provider-specific operations for executing the one or more instances of the one or more additional software modules.

Aspects of the example method, that can be combined with the example method alone or in combination with other aspects, can include the following. A visual representation of the first virtual token container associated with the user can be presented to the user via a first graphical user interface provided by the first digital environment. A visual representation of the second virtual token container associated with the user can be presented to the user via a second graphical user interface provided by the second digital environment. In some implementations, when receiving the request to interact with the first interactive software module, a user selection of a user interface element associated with allocating the number of the first virtual tokens to the execution of the instance of the first interactive software module can be detected via the first graphical user interface.

### BRIEF DESCRIPTION OF DRAWINGS

These and other features will be more readily understood from the following detailed description taken in conjunction with the accompanying drawings.

FIG. 1 is a flowchart of an example method that can be used with aspects of this disclosure;

FIG. 2 is an example graphical user interface presented by a digital environment;

FIG. 3 an example graphical user interface presented by the digital environment;

FIG. 4 is a block diagram of an example system that can be used with aspects of this disclosure;

FIG. 5 is a flow diagram of an example sequence of user interactions within the digital environment; and

FIG. 6 is a block diagram of an example computing device that can be used with aspects of this disclosure.

### DETAILED DESCRIPTION

Online interactive environments such as entertainment platforms and digital applications, typically incorporate virtual economies. For example, users may interact with a variety of software modules (e.g., digital games) in which virtual tokens (e.g., in-game currencies) are used as proxies for value. Generally, these virtual tokens can be accumulated, spent, or exchanged within the digital environment, enhancing user engagement and retention. However, the management and interoperability of virtual tokens across multiple software modules and environments present technical challenges. In particular, systems need to track virtual token balances for large numbers of users, as well as complex interactions (e.g., use, allocation, or conversion of virtual tokens) between heterogeneous modules that may be provided by different third-party vendors. Integration of such disparate software modules is complicated by variations in provider-specific interfaces, event definitions, authentication mechanisms, transaction logic, among others.

Accordingly, methods and systems for operating digital environments are provided. In one implementation, a request to interact with an interactive software module integrated with a digital environment can be received. The request can be associated with a number of first virtual tokens required to interact with the interactive software module. An instance of the interactive software module can be executed in response to receiving the request. A number of second virtual tokens can be generated based on an outcome determined by the interactive software module during the execution. The second virtual tokens are different from the first virtual tokens and are interoperable and transferable for use with interactive software modules integrated with other digital environments. An option to exchange one or more second virtual tokens for at least one redeemable object having an associated monetary value can then be provided.

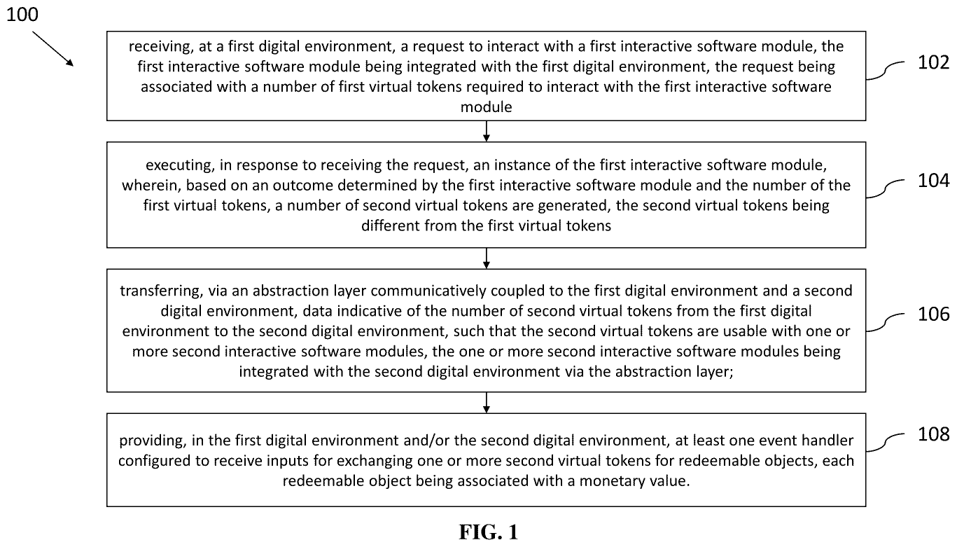

FIG. 1 is a flow chart of an example method 100 that can be used with aspects of this disclosure. At 102, a request to interact with an interactive software module can be received in a digital environment. In various implementations, a digital environment can correspond to a computing system, platform, or service that provides a virtual space in which one or more users can access and interact with one or more software-based features or experiences. The digital environment can be implemented on a server, in the cloud, or on a distributed network of computing devices, and can be configured to host a variety of interactive software modules, manage user accounts, and communicate with one or more external systems or other digital environments.

An interactive software module can include, for example, executable software application or plug-in that delivers a particular interactive experience to the user within the digital environment. Exemplary interactive software modules include digital games, simulations, competitive challenges, or other forms of interactive content. In various implementations, each interactive software module can be integrated within the digital environment via one or more defined interfaces or application programing interfaces (APIs), allowing the interactive software module to access digital environment resources, such as user data, virtual tokens, or other system services, as well as participate in system-wide workflows as described in further detail below. In some cases, one or more interactive software modules can be developed or maintained by different third-party providers. The third-party provider can be an external entity, organization, or service that develops, maintains, or operates one or more interactive software modules intended for integration with the digital environment.

In various implementations, the request to interact with the interactive software module can be generated by a user, typically via a graphical user interface (GUI) presented by the digital environment on a client device, such as a mobile phone, tablet, or computer. In some cases, the GUI can be rendered by the digital environment and transmitted to the client device for display, or in other cases, rendered directly at the client side. The user can visually navigate one or more available options and initiate interactions with different interactive software modules hosted by the digital environment.

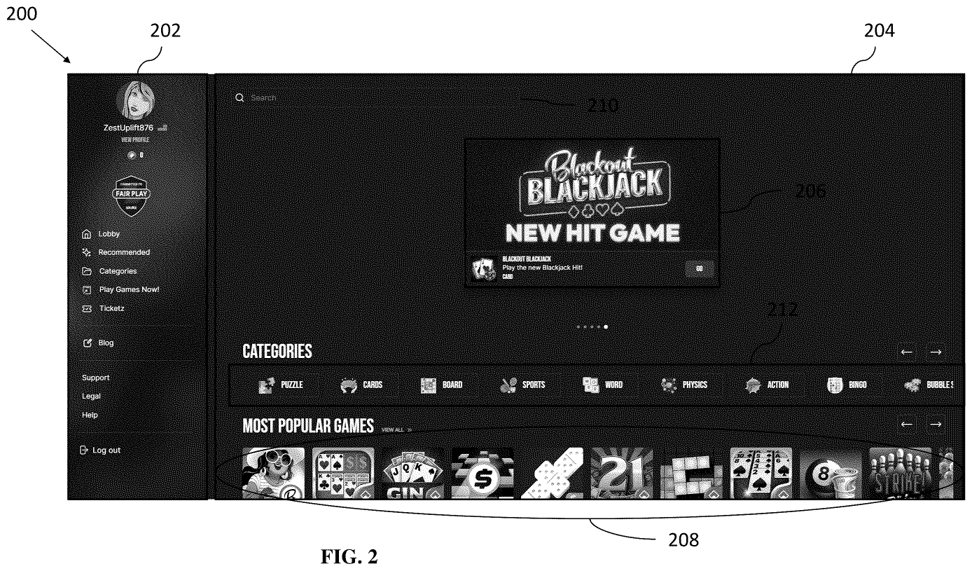

For example, FIG. 2 illustrates an example GUI 200 presented by the digital environment in which requests can be received. As illustrated in FIG. 2, the GUI 200 can include a variety of elements, such as a navigation menu 202 and a display area 204 configured to present interactive content 206 and a set of available interactive software modules 208. It should be understood that the illustrated arrangement of GUI elements in FIG. 2 is merely one example, and that the layout, positioning, orientation, and relative arrangement of the navigation menu 202, display area 204, and other interface components can be varied in alternative implementations.

For example, while FIG. 2 depicts the navigation menu 202 as being rendered along one side (e.g., the left side) of the display, in other implementations, the navigation menu can be rendered along any other side of the GUI (e.g., top, right, or bottom) or can be configured to occupy a different portion of the display area. In some implementations, the navigation menu 202 can be configured to be hidden, minimized, or collapsed by default, and can be presented in partially or fully overlapping manner relative to the central display area 204 upon the occurrence of a user interaction, such as a hover, click, or tap on a minimized control or icon (not shown). Similarly, any of the interface elements, such as interactive content 206 and available interactive software modules 208 can be dynamically modified, for example, in response to system state, personalization logic, or user interaction events as described herein.

As shown in FIG. 2, information related to the user, such as user identifier, username, user status indicator, and quick access to user profile (e.g., URL to user profile) can be displayed in the navigation menu 202. The navigation menu 202 can also include one or more selectable elements for accessing different areas or functions of the digital environment, such as “lobby,” “recommended modules,” “categories,” “balance,” and the like. The interactive content 206 can present one or more featured interactive software modules (e.g., popular digital games or new digital games) and/or personalized advertisement with associated controls (such as a “GO” or “VIEW” button) that, when actuated by the user, generates a request to interact with the respective module. Additional interface elements can include a search bar 210 and category selectors 212 (e.g., “Puzzle,” “Cards,” “Board,” “Sports,” among others), each represented by an icon or visual tile that can be selected to generate an interaction request.

The interaction request can be implemented as a data packet or message transmitted from the client device to a server or cloud service hosting the digital environment. For example, the request can take the form of a Hypertext Transfer Protocol (HTTP) request or a WebSocket message. The request can include a Uniform Resource Identifier (URI) specifying the desired interactive software module or endpoint, as well as a payload containing relevant information, such as a user identifier, session data, a selection of the desired interactive software module, and any additional parameters or metadata required by the desired interactive software module. In some cases, the payload can be formatted using JavaScript Object Notation (JSON), Extensible Markup Language (XML), or other structured data formats commonly used in web-based communication.

In various implementations, the request can specify authentication credentials, device or client information, configuration settings, or user-specific preferences that are relevant for initializing or executing the interactive software module. In some cases, the request can include security tokens, digital signatures, cryptographic hashes, or other verification data to enable secure access to the digital environment and hosted interactive software module. Upon receipt at the server, the digital environment can parse the request, extract relevant data fields, perform validation (e.g., authentication and authorization), and provide an appropriate system response, such as launching an instance of the specified interactive software module or returning an error or confirmation message to the client device.

For example, and referring back to FIG. 1, a request to interact with a particular interactive software module e.g., a casino game can include, for example, a specification of a number of first virtual tokens that are required for the user (e.g., a player) to access or participate in the game among other information as described above. A virtual token can be a digital data or value maintained by the digital environment to represent an abstract unit of value, access, or participation. In some implementations, the virtual token can be a digital representation of credit that can be allocated, transferred, or redeemed within the digital environment or across multiple digital environments, depending on the type of virtual token. For example, the first virtual token refers to a particular type of virtual token that can be used as access tokens that enable or gate entry or participation in one or more interactive software modules within the digital environment.

Continuing the example, the first virtual tokens can represent a unit of wager or allocation of value. In casino games such as a slot machine spin, a hand of blackjack, or a roulette bet, the player may be required to provide a specific amount of currency in order to participate in a round. In such implementation, the first virtual tokens can serve as the digital currency for engaging with the game. In some cases, the number of first virtual tokens can be specified directly by the player, for instance, by entering or selecting a desired wager amount via the GUI. In some implementations, the GUI can include one or more user interface elements associated with allocating the number of the first virtual tokens e.g., a text field, a dropdown, or a slider, configured to detect user input or selection when displayed. Alternatively or additionally, the number of first virtual tokens can be automatically determined based on predetermined module rules or software codes, such as the application of minimum or maximum wager constraints, user levels, or any other game-specific requirements. For example, some digital games may require a minimum wager of a defined amount of first virtual tokens per session or per play or may impose a maximum limit based on player data, regulatory constraints, or current game state.

At 104, an instance of the interactive software module can be executed in response to receiving the request. An instance refers to a specific execution or session of the interactive software module that is uniquely associated with the request. In some implementations, executing the instance can include launching a new session of the interactive software module for the user, which may involve initializing session-specific data, such as a session identifier, user context, initial game states, configuration parameters, among others and allocating necessary resources, such as processor time, memory, or network connections required to run the module. For example, when a player initiates a new round of a casino game, a unique session ID can be generated. The session ID can be associated with a starting balance of virtual tokens, a set of initial game variables (e.g., deck state in a card game or the position of a slot machine's reels), and any server-side resources reserved to execute the game logic.

During or subsequent to the execution of the instance of the interactive software module, an outcome (e.g., a result or conclusion) can be determined. In some implementations, the outcome can be determined by the interactive software module in response to user input and/or algorithmic processes executed within the module. For example and as described above, when the interactive software module is a casino game, the outcome can correspond to a win, loss, or draw, and can be determined based on game-specific rules implemented by the module, such as game logic for evaluating winning combinations in a slot machine or point totals in a card game. In various implementations, the outcome can result in the user being eligible to receive a digital reward, incentive, or prize e.g., virtual tokens, advancement to a higher status or level within the system, unlocking of additional interactive software modules or features, issuance of digital badges or achievements, loyalty points, or eligibility to participate in further events or promotions.

For example, if the outcome of the executed instance of the interactive software module meets at least one predefined criterion (e.g., the user achieves a win, a lose, or a draw), a number of second virtual tokens can be credited to the user. The second virtual token is a type of virtual token that is distinct from the first virtual token used to access or participate in the interactive software module. In various implementations, the second virtual tokens can possess different properties and uses compared to the first virtual tokens. The second virtual tokens can be accumulated, stored, or transferred independently from the first virtual tokens. In various implementations, the second virtual tokens can be eligible for exchange or redemption for digital or physical rewards. In alternative implementations, the second virtual tokens can be used for entry into special events or transferred across different digital environments or modules as further described herein. The number of second virtual tokens to be credited to the user can be determined based on a predefined reward schedule, the number of first virtual tokens allocated or wagered by the user, and/or stochastic processes.

In some implementations, the number of second virtual tokens awarded to the user can be calculated according to a payout table or prize matrix associated with the game logic, which maps particular outcomes, such as winning combinations or specific achievements, to corresponding quantities of second virtual tokens. The number of second virtual tokens credited can also be directly or indirectly proportional to the number of first virtual tokens allocated, wagered, or otherwise committed by the user during the session. For example, depending on which interactive software module the user interact with, a predetermined multiplier e.g., a bonus coefficient can be applied to the number of first virtual tokens, such that a higher number of first virtual tokens wagered results in a higher potential reward or loss in the form of second virtual tokens. In such implementation, the number of second virtual tokens to be credited to the user can be a negative value. For example, if the outcome of the executed instance or the interactive software module corresponds to a loss, penalty, or reversal event (e.g., failed wager, breach of module rules, or correction of a previous transaction error), the number of second virtual tokens can be deducted from user's account.

To this end, the digital environment can be configured to verify that the user possesses a sufficient number of first virtual tokens to initiate the interaction. For example, if the digital environment determines that the user's available balance of the first virtual tokens meets or exceeds the required amount, the instance of the interactive software module can be executed for the user. In such cases, the interactive software module can interact with the user by presenting game interface, accepting user input (e.g., selections, commands, or wagers), and generating an outcome based on one or more software processes as described herein. Conversely, if the verification determines that the user does not possess a sufficient number of the first virtual tokens, the digital environment or the interactive software module can prevent execution of the instance, and present, in some cases, a message or notification to the user, such as a prompt to acquire additional tokens, a warning of insufficient balance, or instructions for alternative actions (e.g., returning to the lobby or accessing a different module).

The digital environment can provide multiple mechanisms for users to obtain both first and second virtual tokens. The digital environment may offer the user options to obtain more first virtual tokens through one or more system-defined processes (such as purchases, bonuses, or other allocations), or may automatically trigger free token allocation events, such as daily login rewards and welcome gifts for newly registered users. In some implementations, the digital environment can support user-initiated transactions for acquiring additional first virtual tokens. For example, users can engage with special offers or participate in limited time promotions to initiate transactions. The user-initiated transaction can be triggered, for instance, when the user selects or interacts with an offer displayed within the GUI such as clicking a “BUY” or “CLAIM” button associated with the offer.

The first and second virtual tokens can be stored in corresponding virtual token containers associated with the user. The virtual token container can be implemented as a logically separated data structure configured to maintain, update, and track a balance or record of virtual tokens of a particular type for a given user within the digital environment. In some implementations, a first virtual token container can be dedicated to storing first virtual tokens, while a second virtual token container can be dedicated to storing second virtual tokens. The second virtual token container can be maintained and tracked separately from the first virtual token container to support clear separation of roles as described herein. For example, the virtual token container can be implemented as a data structure in system memory (e.g., in-memory object, array, or hash map), a record in a persistent database (e.g., a row in a relational database table, a document in a NoSQL database, or a field in a distributed ledger or blockchain), or an entry in a key-value store or a property of a user profile object associated with the user.

The digital environment can update the respective virtual token containers to reflect a variety of state changes. For example, when the user submits the request to interact with interactive software module, the system can update the first virtual token container by deducting the number of first virtual tokens required for the interaction, Conversely, when the interactive software module is executed and the outcome is determined, the second virtual token container can be updated by crediting the number of second virtual tokens to the user. Alternatively or in addition, the virtual token container can be temporarily frozen or locked during a pending transaction, such as when the user initiates a wager or participates in a challenge where the final outcome is not yet determined. In some cases, virtual tokens can also be locked in response to dispute, suspected fraud, audit, or system maintenance, preventing affected tokens from being spent, transferred, or redeemed until the freeze is lifted.

As indicated above, second virtual tokens can only be awarded through engagement with interactive software modules, participation in tournaments, competitions, or community events within the digital environment. However, in some implementations, the user can receive a bonus allocation of second virtual tokens when purchasing any amount of first virtual tokens. The bonus amount of the second virtual tokens awarded in such transactions can be determined based at least in part on the user's loyalty progression or tier status within the digital environment. For example, as the user advances through higher loyalty tiers, the bonus amount of the second virtual tokens can be increased. This can provide greater incentives for the user's continued participation. It should be noted that the second virtual token cannot be directly purchased by the user but can only be obtained through system-defined processes as described herein.

To this end, the bonus amount of the second virtual tokens can vary between different users. For example, the bonus amount of the second virtual tokens can be determined based on a token multiplier corresponding to the user's current loyalty progression or tier status within the digital environment. Specifically, when a transaction is processed that results in the awarding of second virtual tokens (e.g., purchase of first virtual tokens accompanied by a bonus), a multiplier value associated with the user's tier level can be determined. The bonus can be calculated based on the multiplier value accordingly. A user at a higher tier can receive a greater bonus of second virtual tokens for the same transaction amount compared to a user at a lower tier. In some implementations, the tier level can be dynamically updated in response to users ongoing activity. For instance, upon detecting that the amount of second virtual tokens accumulated by the user during a predetermined time period (e.g., a rolling 30-day window) exceeds a defined threshold, the user can be automatically promoted to a higher tier level, resulting in more favorable multipliers or additional benefits.

Additionally, the user can accrue second virtual tokens through participation in a first interactive software module and subsequently use or further accrue those tokens in a second interactive software module. In some cases, the first interactive software module and the second interactive module can be integrated within the same digital environment. In other cases, however, the first interactive software module and the second interactive software module can be integrated with different digital environments, each potentially operated on distinct computing systems, networks, or platforms. To this end, at 106, data indicative of the number of second virtual tokens can be transferred, via an abstraction layer, from one digital environment to another. This allows the user to carry and use their earned second virtual tokens across different digital environments, even when systems are operated independently. The second virtual tokens earned in one digital environment can thus be recognized, accepted, and applied within another digital environment.

The abstraction layer can include one or more software components, middleware frameworks, or APIs used to communicate or transfer data between different digital environments and interactive software modules integrated therein. In some implementation, the first interactive software module and the second interactive software module can be developed or maintained by different third-party providers. It should be noted that the third-party provider may offer interactive software modules through proprietary or public-facing APIs, software development kits (SDKs), or service endpoints, and may define unique protocols, data formats, authentication methods, event schemas, and operational rules for the modules they supply. In various implementations, the third-party providers are distinct from the operators or maintainers of the digital environments and can continuously update or modify their software modules independently of the digital environment's core system.

The abstraction layer can be implemented as a set of system services, microservices, or interface libraries that encapsulate the complexity and variation present in provider specific APIs, data formats, security protocols, authentication schemes, session management requirements, and the like. In some implementations, the abstraction layer can be configured to perform protocol translation, response conversion, message routing, data normalization, and the like to support update and integration of interactive software modules within respective digital environments. The abstraction layer can standardize provider-specific interfaces, event definitions, transaction logic, error handling procedures, authentication flows, etc., by mapping differing event schemas, (interactive software module execution) outcome representations, or state transition from various third-party providers into a uniform system data model that is recognizable by the digital environment. In some cases, different digital environments can each implement their own abstraction layer, with each abstraction layer tailored to specific technical requirements (e.g., data models, provider integrations, and the like). In other cases, multiple digital environments can be communicatively coupled to a common abstraction layer.

For example, when the request (e.g., request to participate in a selected interactive software module such as a casino game provided by a third-party provider) is received by the digital environment, the abstraction layer can be configured to determine an appropriate provider-specific adapter required to interact with the selected interactive software module. The provider-specific adapter can be a software component, interface library, or set of routines implemented to encapsulate and manage all or part of interactions with a particular interactive software module. For example, the provider-specific adapter can implement a set of standardized operations for executing the selected interactive software module in the digital environment. Specifically, the provider-specific adapter can translate the system-standard session creation request into a provider specific API call or message format. Such session creation can involve generating a provider-specific authentication token, mapping user related information to the provider's schema, and invoking a session creation endpoint defined by the provider's API to create an instance of the interactive software module.

Continuing the example, once the session is successfully established, the abstraction layer can manage communication between the digital environment and the interactive software module for the duration of the user's participation. This can include, for example, forwarding user actions (e.g., placing a wager, selecting or submitting an input specifying the number of first virtual tokens) to the instance of the interactive software module provider in an appropriate data format and protocol. Throughout the session, the abstraction layer can monitor and translate event notification or state updates generated by the interactive software module into standardized system events that are consistent with data models employed by the digital environment. When the interactive software module completes execution (e.g., the round of the casino game concludes), an outcome such as a win, loss, or draw can be generated and transmitted to the digital environment via the abstraction layer. For instance, if the instance returns outcome data in a proprietary JSON or XML schema, the abstraction layer can parse the response, extract relevant results (e.g., prize type and/or amount) and reformats the information into a standard system outcome object. The digital environment can then credit the number of second virtual tokens to the user based on the standard system outcome object.

Data such as user identifier (e.g., a unique user account ID or system-wide GUID), transaction identifiers (e.g., session ID), timestamps, verification information (e.g., digital signatures, cryptographic hashes, or authorization tokens), and any transaction metadata can be transferred in addition to the amount or balance of second virtual tokens. In some implementations, these data can be formatted as a payload and transferred between digital environment via, for example, RESTful APIs or other network-based protocols (e.g., TLS/SSL). In alternative implementations, the second virtual token balances can be reflected in a shared, replicated, or synchronized database accessible by different digital environments. In such cases, the “transfer” of the number of second virtual tokens from one digital environment to another may not require the physical movement of data between different digital environments but instead can be accomplished by updating the user's token balance in the shared database.

Further, the second virtual tokens can be subsequently used to redeem various items or benefits. At 108, an event handler can be provided across different digital environments for receiving user inputs to exchange one or more second virtual tokens for redeemable objects. Redeemable objects can include any digital or physical item, benefit, or entitlement that a user may acquire or claim in exchange for a specific number of second virtual tokens. Each redeemable object can be associated with a monetary value, which can be predetermined, dynamically calculated, or based on external criteria such as market price or system policy. The event handler can be implemented as a software function or process configured to detect, receive, and process user inputs indicating a request to exchange second virtual tokens for a redeemable object. The event handler can operate in conjunction with a GUI element, such as a button, selection list, or drag-and-drop area, presented to the user within the digital environment. Upon receiving such input, the event handler can initiate a sequence of system operations e.g., validating user eligibility, verifying available token balance, executing the redemption transaction, updating user information, and generating notifications or receipts to the user.

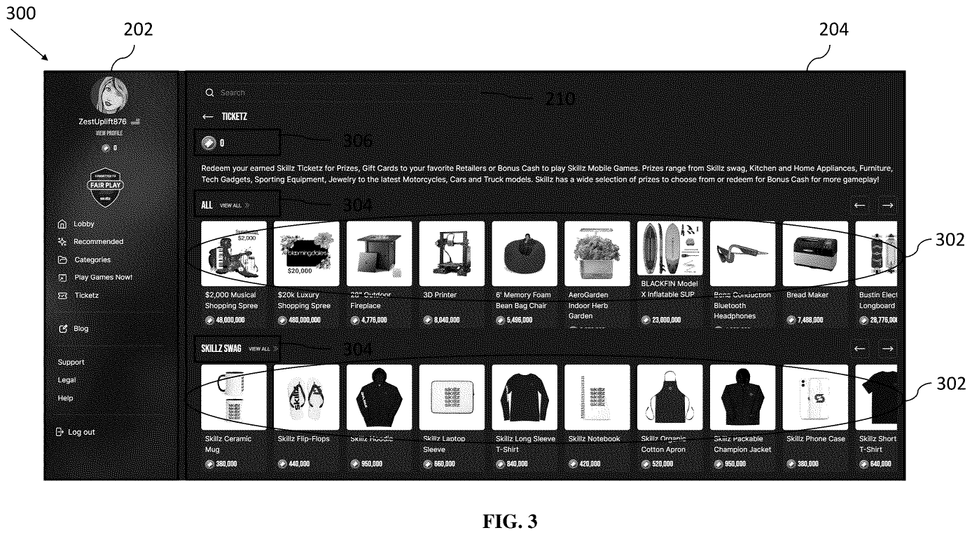

For example, FIG. 3 illustrates an example GUI 300 presented by the digital environment configured to display a catalog or marketplace of multiple redeemable objects 302. In some implementations, GUI 300 can be accessible from the navigation menu 202 as described above with reference to FIG. 2. For example, the user can select “balance” or similar menu item from the navigation menu 202, causing the display area 204 to be updated to present the interface depicted in FIG. 3. As shown in FIG. 3, each redeemable object 302 can be visually represented by an image, descriptive text, and an indication of the number of second virtual tokens required for redemption. The GUI 300 can provide category filters 304 or search bar 210 to assist the user in browsing and locating specific redeemable objects. The event handler can be associated with a selectable button, icon, or image corresponding to each redeemable object. For example, each redeemable object 302 can be presented with an interactive control that when selected by the user, triggers the event handler to receive and process the redemption request.

In some implementation, the virtual token containers can be visualized in GUI 300. For example, the GUI 300 can also display the user's current balance of second virtual tokens, typically positioned on the top of GUI 300 for prominence and clarity. In some cases, such visual representation 306 can be presented across multiple digital environments. For example, via a first GUI provided by the first digital environment (e.g., a social casino platform), both visual representations of the first and second virtual token containers associated with the user can be displayed, allowing the user to quickly assess their available resources for game play or redemption. However, only the visual representation of the second virtual token container can be displayed via a second GUI provided by the second digital environment (e.g., a competitive gaming platform or another interoperable application). This allows the user to view, manage, and utilize second virtual tokens consistently regardless of which digital environment they are currently accessing.

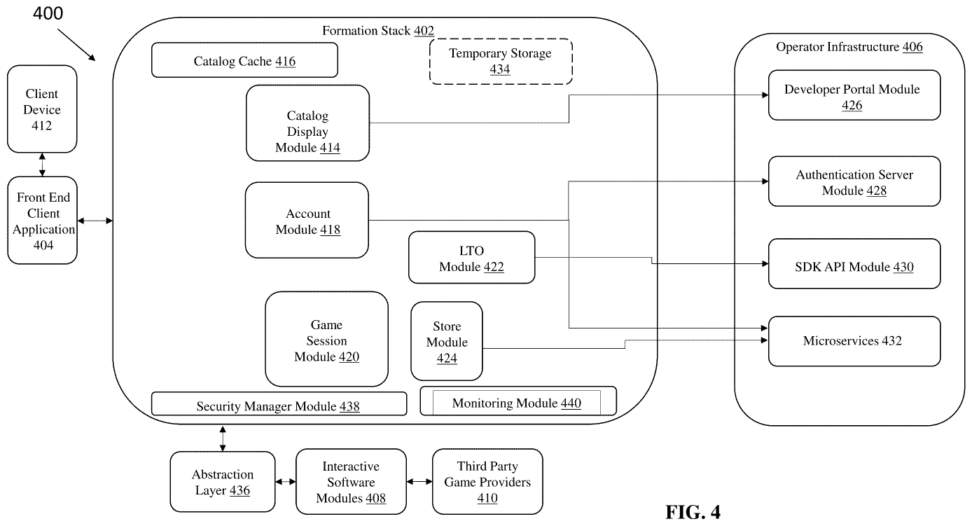

FIG. 4 illustrates an example system 400 configured to execute all or part of the method 100. In the illustrated embodiment, the system 400 can be implemented as a social casino-based gaming platform as described above with reference to FIGS. 1-3. The social casino-based gaming platform can provide users with access to games of chance or skill such as slots, card games, or other casino games wherein users can engage for entertainment. The system 400 can include a serverless cloud-based stack (e.g., formation stack 402) communicatively coupled with a front-end client application 404 and an existing software and information technology (IT) infrastructure utilized by a system operator (e.g., operator infrastructure 406) to control operation of the system 400, such as operations of social casino gaming applications (e.g., interactive software modules 408 provided by third-party game provider 410) on various client devices 412.

The front-end client application 404 can be hosted in an AWS S3 bucket and distributed via CloudFront CDN endpoints. The front-end client application 404 can provide GUI accessible to users through web browsers or mobile applications running on the client device 412. In some implementations, the front-end client application 404 can communicate with one or more backend system components via secure HTTPS connections and RESTful API calls. Exemplary backend system components can include, as shown in FIG. 4, distributed computing components and managed services (e.g., Amazon Web Services), such as a catalog display module 414, an account module 418, a game session module 420, a limited time offer (LTO) module 422, and a store module 424. Each module can be responsible for distinct system functionality. In some cases, each module can be implemented using a set of stateless, event-driven computing resources such as AWS functions, and can interact with one or more other modules internally via secure, authenticated APIs or event-driven messaging.

The operator infrastructure 406 can include a suite of IT components used by the system operator to further support and/or extend the backend system components in the formation stack 402. In some implementations, the operator infrastructure 406 can include, as shown in FIG. 4, a developer portal module 426, an authentication server module 428, a SDK API module 430, and a collection of microservices 432. Each module in the formation stack 402 can be communicatively coupled to respective one or more modules in the operator infrastructure 406 via various virtual private cloud (VPC) networks. For example, the catalog display module 414 can be communicatively coupled to a developer portal module 426 of the operator infrastructure 406 through one or more API endpoints (e.g., mobile games list API end point, social casino games list API endpoint, and/or get game end point).

In some implementations, the catalog display module 414 can generate and present up-to-date games or reward catalogs to users via the front-end client application. The catalog display module 414 can query developer portal module 426 and/or a catalog cache 416 via VPC networks for available games or software modules, organize content by category, feature, or promotions, and update the GUI in response to user actions, search queries, or promotional events. The catalog cache 416 can store instances of available interactive software modules 408 and/or redeemable objects. In some cases, the catalog cache 416 can be implemented using managed cache services (e.g., AWS ElastiCache) to accelerate user queries and minimize latency when presenting catalogs to users. The catalog cache 416 can be routinely refreshed and synchronized with the latest data from connected third-party game provider 410 and the catalog display module 414.

Similarly, the account module 418 can interface with the authentication server module 428 to manage user account creation, credential validation, and authentication. For example, when a new user registers with the platform, the account module 418 can communicate with the authentication server module 428 to securely create a new user account, establish credentials, and generate initial authentication tokens. When an existing user logs in, the account module 418 can coordinate with the authentication server module 428 to validate credentials, refresh authentication tokens as needed, and retrieve user identity and authorization information. In some cases, both catalog display module 414 and the account module 418 can access a temporary storage 434 configured to hold transient data e.g., cache catalog data such as lists of available games and/or redeemable objects and session-related information such as login tokens, temporary profile updates, verification states, and the like that need to be rapidly accessed or updated during active user sessions. In some implementations, the temporary storage using a low-latency data store such as an in-memory database (e.g., Amazon DynamoDB with TTL features or Redis via AWS ElastiCache).

In order to manage the full lifecycle of user participation in interactive software modules (e.g., execution of the interactive software module instances), the game session module 420 can be configured to initiate and terminate game sessions. In some implementations, the game session module 420 can receive start session and end session requests from the front-end client application 404 via secure HTTPS connections and processes these requests in real time. For example, upon receiving a start session request, the game session module 420 can authenticate the user, verify session eligibility and resource availability by communicating with the account module 418 (e.g., to confirm token balances and user status), and query the catalog display module 414 for relevant session or game information.

In some implementations, the game session module 420 can utilize back-channel API connectors (e.g., provider-specific adaptors provided by an abstraction layer 436) to standardize communication with the back-end APIs of integrated third-party game providers 410 over back-channel HTTPS connections. Through these connectors, the game session module 420 can relay session initiation commands, user actions, and other gameplay data to the third-party providers, as well as receive outcome or event notifications in a format compatible with the social casino platform. In such implementations, new games (e.g., additional interactive software modules) can be integrated into the system via the abstraction layer 436 in a manner (e.g., plug-and-play integration) that does not require modification of any existing backend system components. The abstraction layer 436 can be configured to provide provider specific adaptors, each implementing a set of standardized operations (e.g., session initiation, balance inquiry, outcome reporting, rollback, and authentication) supporting respective game sessions.

In some cases, during the lifecycle of each session, the game session module 420 can also interface with one or more microservices 432 provided by the operator infrastructure, such as, for example, a transaction log entry microservice. The transaction log entry microservice can record transactional data such as wagers (e.g., the number of first virtual tokens associated with the start session request), session outcomes, wins/losses, and token allocations, and provide auditable logs of all game-related activities. In some cases, at session completion, the game session module 420 can update all relevant modules, log the session details, and provide outcome data to the account module 418 for accurate adjustment of virtual token containers and loyalty status. Simultaneously, the game session module 420 can notify the catalog display module 414 for updating the GUI to present, for example, a reward display or other promotional content such as available offerings.

In some implementations, the LTO module 422 can be configured to generate, present, and process one or more offers, each of which may correspond to a user-initiated transaction as described above to eligible users within the digital environment. The LTO module 422 can leverage input from the account module 418 (e.g., user tier, activity history, or token balance), event triggers from the game session module 420 (e.g., session completions or low-balance events) to dynamically construct offers tailored to individual users. These offers can be presented to users through the GUI, where each offer can be presented by an interactive graphical element such as a button, card, banner, pop-up that, when actuated by the user, initiates a user-initiated transaction. Processing the user-initiated transaction can include updating the first virtual token container to reflect an increase in the amount of first virtual tokens acquired through the transaction, as well as updating the second virtual token container to reflect a bonus allocation of second virtual tokens associated with the offer.

In some implementations, the LTO module 422 can be configured to trigger user-initiated transaction automatically in response to certain system events or user states. For example, the module can detect when a user accesses the digital environment (e.g., logs in or returns after a period of inactivity) and automatically present a daily login offer, which upon user acceptance, results in a transaction that credit additional first virtual tokens to the first virtual token container. Similarly, the LTO module 422 can monitor the amount of first virtual tokens stored in the first virtual token container (e.g., user's balance of first virtual tokens) through data provided by the account module 418, and upon detecting that the balance has fallen below a predetermined threshold, generate and present a targeted “top-up” or bonus offer for the user to buy or claim.

The user-initiated transaction can be alternatively or additionally triggered by events corresponding to a temporary or otherwise restricted window of opportunity for the user to increase the amount of first virtual tokens and/or second virtual tokens stored in the respective virtual token containers associated with the user (e.g., limited time offers). In some implementations, LTO module 422 can generate such offers based on defined schedules e.g., hourly, daily, or weekly cycles. When the limited time offer is generated and active, the LTO module 422 can display the limited time offer prominently within the GUI. The offer can specify the quantity of first virtual tokens and bonus second virtual tokens available for acquisition, the eligibility criteria for participation (e.g., minimum activity level, tier status, or prior engagement), and the time remaining for the offer to be claimed. The user can initiate a transaction to accept the offer by interacting with a selectable control on the displayed offer. Once the time window for the offer has elapsed, the LTO module 422 can automatically expire or deactivate the offer, ensuring that it is no longer available until the next scheduled or triggered event.

In some implementations, the LTO module 422 can generate one or more limited time offers based on real-time analysis of user activity and engagement patterns within the platform. For example, both the LTO module 422 and the account module 418 can communicate with the SDK API module 430 in the operator infrastructure 406 to collect and process user interaction data. The user interaction data can include session frequency, game participation, purchase history, response to previous offers, and engagement with specific features. In some cases, the LTO module 422 and/or other backend system components described herein can be configured to classify users into distinct user segments (e.g., user categories) based on such user interactions. This classification can be performed using rule-based segmentation logic or, in some implementations, through the application of one or more machine learning models trained to recognize behavioral patterns associated with different user types or engagement levels.

The user segments can be defined, for example, by metrics such as activity frequency (e.g., daily, weekly, or infrequent users), purchase behavior (e.g., spenders or free-to-play players), engagement propensity (e.g., offer-responsive users or dormant users), or the like. For example, a rule base engine (e.g., a decision logic module) can be deployed to receive data characterizing user activity and output a corresponding user segment classification according to one or more pre-defined rules or thresholds. Alternatively or additionally, an ML model, such as decision trees, support vector machines (SVMs), neural networks, and the like can be trained on historical user interaction data to identify patterns in behavior and automatically assign users to one of many user segments. The ML model can receive user related data and output a predicted user segment label for each user.

Further, the store module 424 can be configured to facilitate the redemption of virtual tokens and redeemable objects within the social casino platform. In some implementations, the store module 424 can aggregate and present, in conjunction with account module 418 and catalog display module 414, the first and/or second virtual token container associated with the user, a catalog of available items including, for example, packages of first virtual tokens, and redeemable objects such as digital rewards, physical goods, promotional entries, and the like via the GUI. In some cases, the store module 424 can interface with the account module 418 and the SDK API module 430 to securely manage transactions affecting user balance e.g., adjustment of second virtual token container in response to redemptions or refunds. Purchases and redemptions made through the store module 424 can be initiated by explicit user actions (e.g., selecting a “buy” or “redeem” button in the GUI), acceptance of limited time offers generated by the LTO module 422, or through automated triggers based on system-defined rules or user events. The store module 424 can then update transaction histories and notify users of successful purchases or redemptions.

In some implementations, the store module 424 can be configured to enable cross-platform access to the store interface and its catalog of redeemable objects. For example, a user can access the store page of the social casino platform while participating in a competitive game platform, or vice versa. In alternative implementations, the store module 424 can be operable to present a unified or shared catalog of redeemable objects. Users can use their accumulated second virtual tokens for redemption or purchase of items regardless of the originating platform or digital environment.

The formation stack 402 can further include dedicated modules for infrastructure security and operational monitoring (e.g., security manager module 438 and monitoring module 440). In some implementations, the security manager module 438 can be configured to ensures that only authorized users, system components, and external services are permitted to access sensitive resources or execute privileged operations. The security manager module can store and/or retrieve sensitive information, such as API keys, encryption keys, database credentials, and authentication tokens. For example, the security manager module 438 can include a combination of Identity and Access Management (IAM) service and a secret manager service. The monitoring module 440 can collect, aggregate, and analyze operational telemetry across all modules as described herein to generate audit logs of system events, trigger alerts in response to anomalous condition, and perform real-time or retrospective diagnostics of system 400 health and performance.

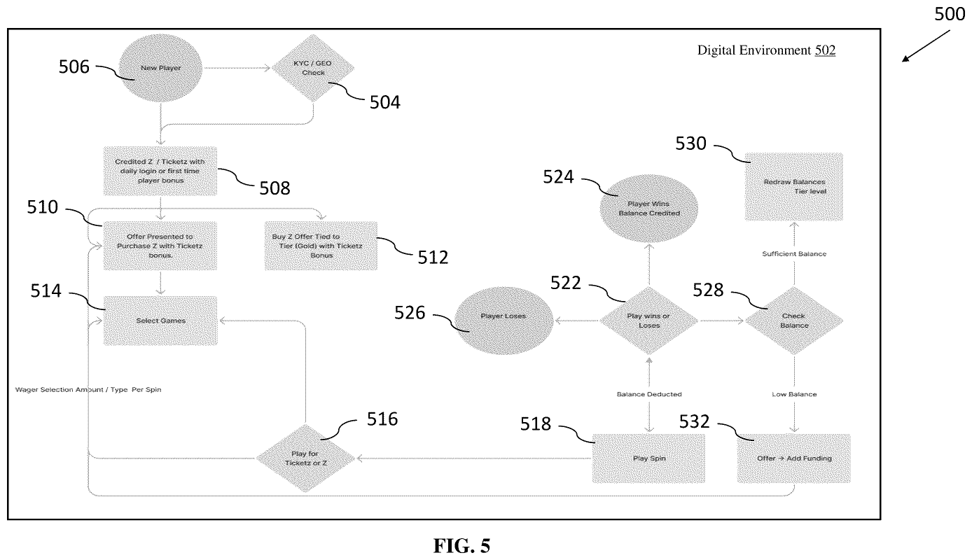

FIG. 5 is a flow diagram illustrating an example sequence of user interactions 500 within a digital environment 502. In the illustrated implementation, the digital environment 502 can be configured as a social casino-based gaming platform as described above with reference to FIG. 4. In such digital environment and as indicated above, the users can accrue virtual tokens and potentially redeem rewards, but the users cannot wager or receive real-world currency directly though game play.

As shown in FIG. 5, the digital environment 502 can perform a verification check 504 when a user 506 attempts to access or interact with certain features, such as upon initial registration, login, or prior to participating in specific interactive software modules to ensure compliance with regulatory requirements, platform policies, and to maintain the integrity and security of the digital environment 502. In some implementations, the verification check 504 can include a Know-Your-Customer (KYC) check, a geographic (GEO) location check, device or session validation, or other authentication checks.

For example, a GEO location check can be performed to confirm that the user 506 is accessing the platform from a permitted jurisdiction, as certain features or games may only be available in specific geographic locations due to legal or licensing constraints. The digital environment 502 can collect location data (e.g., GPS coordinates, IP address geolocation, or Wi-Fi triangulation) from the client device via secure API call, analyze the collected location data against an allowed list of jurisdictions. In various implementations, if the user 506 passes the verification check 504 (e.g., the location is permitted), the digital environment 502 can allow the user 506 to proceed, such as registering, accessing games, redeeming rewards, or participating in specific activities.

Upon successful verification, the user 506 can be credited with one or more first virtual tokens and/or second virtual tokens as part of a daily login or first-time player bonus (508). However, if the user 506 fails the check (e.g., the location is restricted), the digital environment 502 can block access to certain modules or features, displaying a notification explaining the restriction, and/or prompt the user 506 to adjust settings (e.g., disabling VPNs or updating device location permissions). In some cases, the verification check 504 can be performed synchronously (e.g., blocking access until a result is returned) or asynchronously (e.g., updating permissions or access as new data becomes available).

It should be noted that verification check 504 as described herein can be performed at various points throughout the user's interaction with the digital environment. For instance, even after registration, a check can be performed each time the user 506 attempts to launch a game, redeem a prize, claim a limited time offer, or access account features. When an existing player originally registers in one jurisdiction, then later attempts to play a game while traveling to another location, the digital environment 502 can perform a GEO check at the point of initiation game play. If the new location is permitted, the game session proceeds normally, otherwise, the launching of the game may be blocked. The user 506 can be notified and any further activity that is not allowed in the current jurisdiction can be prevented.

The user 506 can be presented with one or more offers to purchase additional first virtual tokens (510). Such presentation can be triggered based on system-defined events e.g., low balance, loyalty progression, tier level promotion, and the like. As indicated above, the purchase of additional first virtual tokens can be bundled with second virtual token bonuses (512). The user can select a game from the available catalog (514) and specify a wager selection amount and type (516) for each play or spin (518). The available catalog can be dynamically populated and displayed by catalog display module 414 as described above with reference to FIG. 4.

During each play or spin (518), the selected interactive software module can be executed by the system (e.g., via the game session module 420), and the appropriate amount can be deducted from the user's account. The deduction can occur from the first virtual token container, or from the second virtual token container if the game supports play with second virtual tokens. An outcome, e.g., win or loss can then be determined according to the game logic (522). If the user 506 wins, the number of second virtual tokens can be credited (524); if the user 506 loses, the balance of the first virtual tokens (or the balance of the second virtual tokens if the user 506 is playing with the second virtual tokens) can be deducted accordingly (526).

In various implementations, the execution of the interactive software module can be an iterative process, wherein the software module can be executed in a loop or in repeated plays as long as the user elects to continue participating and sufficient virtual token balance remains. After each iteration, the system can perform a balance check (528). For example, if the virtual token containers contain sufficient virtual tokens (i.e., user's balance is sufficient), the game may continue and the system may update relevant modules e.g., catalog display module 414 and account module 418 to reflect changes in balances or achievement of new tier levels (530); however, if there are insufficient virtual tokens (i.e., user's balance is low), the system may configure LTO module 422 to generate one or more personalized offers to add funding (532). Throughout this process, user activity and outcomes can be recorded by microservices 432 to support subsequent analytics, auditing, and generation of personalized offers.

In various implementations, the outcome can be determined, at least in part, by a random process. The interactive software module (e.g., the game of chance) can invoke a random number generator (RNG) to produce one or more random values that can be used to resolve game outcomes, such as determining whether the user wins, loses, or the specific result of a spin, card draw, or other random events. The RNG can be a software component configured to generate a sequence of values that are statistically independent and unpredictable, thereby simulating randomness for purposes of fair outcome determination. The RNG can be implemented as a pseudorandom number generator (PRNG) using deterministic algorithms and regularly updated seeds, a true random number generator (TRNG) that incorporates entropy from physical sources, or a hybrid RNG.

In some cases, the RNG can be provided by third-party game provider 410 and implemented directly within the interactive software module and seeded by user actions, trusted time, or any other environmental variables. The random values can be generated and managed by the third-party game provider 410 and transmitted securely to the game session module 420 for use in resolving game results. In some cases, all generated random values and seeds are logged, timestamped, and made available for subsequent verification checks or dispute resolution. The RNG as described herein ensures that each game outcome is fair, unpredictable and resistant to manipulation.

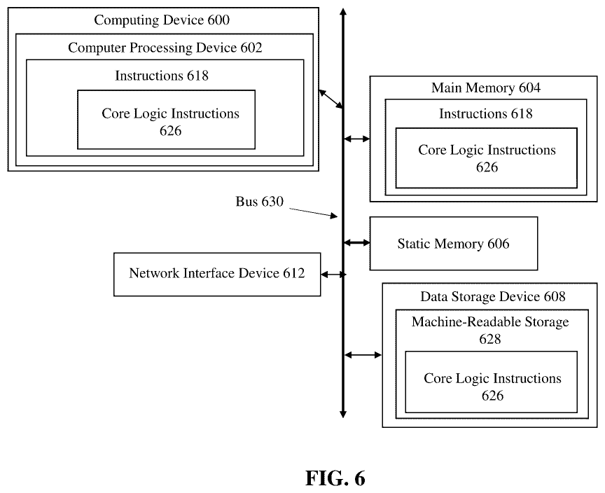

FIG. 6 is a block diagram of an example computing device 600 that may perform one or more of the operations described herein, in accordance with the present aspects. The computing device 600 can correspond to client device and/or one or more backend system components or modules as described above with reference to FIGS. 1-5. The computing device 600 may be connected to other computing devices in a LAN, an intranet, an extranet, and/or the Internet. The computing device 600 may operate in the capacity of a server machine in client-server network environment or in the capacity of a client in a peer-to-peer network environment. The computing device 600 may be provided by a personal computer (PC), a set-top box (STB), a server, a network router, switch or bridge, or any machine capable of executing a set of instructions (sequential or otherwise) that specify actions to be taken by that machine. Further, while only a single computing device 600 is illustrated, the term “computing device” shall also be taken to include any collection of computing devices that individually or jointly execute a set (or multiple sets) of instructions to perform the methods discussed herein.

The example computing device 600 may include a computer processing device (e.g., a general purpose processor, ASIC, etc.), a main memory 604, a static memory 606 (e.g., flash memory or the like), and a data storage device 608, which may communicate with each other via a bus 630. The computer processing device 602 may be provided by one or more general-purpose processing devices such as a microprocessor, central processing unit, or the like. In an illustrative example, computer processing device 602 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. The computer processing device 602 may also comprise one or more special-purpose processing devices, such as an application specific integrated circuit (ASIC), a field programmable gate array (FPGA), a digital signal processor (DSP), network processor, or the like. The computer processing device 602 may be configured to execute the operations described herein, in accordance with one or more aspects of the present disclosure, for performing the operations and steps discussed herein.

The computing device 600 may further include a network interface device 612, which may communicate with a network 614. The data storage device 608 may include a machine-readable storage medium 628 on which may be stored one or more sets of instructions, e.g., instructions for carrying out the operations described herein, in accordance with one or more aspects of the present disclosure. Instructions 618 implementing core logic instructions 626 may also reside, completely or at least partially, within main memory 604 and/or within computer processing device 602 during execution thereof by the computing device 600, main memory 604 and computer processing device 602 also constituting computer-readable media. The instructions may further be transmitted or received over the network 614 via the network interface device 612.

While machine-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media, magnetic media, and the like.

The subject matter described herein provides many technical advantages. For example, some implementations of the present subject matter can improve the efficiency and processing capabilities of computer hardware resources (e.g., computer processing and memory) to identify matches by supporting and providing substantially faster matching times, particularly for client applications with large numbers of users (e.g., hundreds of thousands, millions, tens of millions, etc. of users). For example, some implementations of the present subject matter can more efficiently handle large numbers of users enqueuing and identifying matches in a plurality of templates at the same time. By improving the matching speed and efficiency for client applications with large numbers of users, computer hardware resources can be freed up more quickly and used for other tasks and processes, resulting in a significant improvement in computer resource utilization.

Aspects of the subject matter and the operations described in this disclosure can be implemented in digital electronic circuitry, or in computer software, firmware, or hardware, including the structures disclosed in this disclosure and their structural equivalents, or in combinations of one or more of them. Aspects of the subject matter described in this disclosure can be implemented as one or more computer programs, i.e., one or more modules of computer program instructions, encoded on computer storage medium for execution by, or to control the operation of, data processing apparatus. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this disclosure can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer processing device, a computer, a system on a chip, or multiple ones, or combinations, of the foregoing. A computer processing device may include one or more processors which can include special purpose logic circuitry, e.g., an FPGA (field programmable gate array) or an ASIC (application specific integrated circuit), a central processing unit (CPU), a multi-core processor, etc. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative, procedural, or functional languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto optical disks, optical disks, solid state drives, or the like. However, a computer need not have such devices. Moreover, a computer can be embedded in another device, e.g., a smart phone, a mobile audio or media player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, aspects of the subject matter described in this specification can be implemented on a computer having a display device, e.g., a CRT (cathode ray tube), LCD (liquid crystal display) monitor or the like, for displaying information to the user and a keyboard and a pointing device, e.g., a mouse, a trackball, a touchpad, a stylus, or the like, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Aspects of the subject matter described in this disclosure can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this disclosure, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), peer-to-peer networks (e.g., ad hoc peer-to-peer networks), and the like.

The computing system can include clients and servers. A client and server are generally remote from each other and typically interact through a communication network. The relationship of client and server arises by virtue of computer programs running on the respective computers and having a client-server relationship to each other. In some aspects, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Reference throughout this disclosure to “one aspect” or “an aspect” means that a particular feature, structure, or characteristic described in connection with the aspects included in at least one aspect. Thus, the appearances of the phrase “in one aspect” or “in an aspect” in various places throughout this disclosure are not necessarily all referring to the same aspect. In addition, the term “or” is intended to mean an inclusive “or” rather than an exclusive “or.”

While this disclosure contains many specific implementation details, these should not be construed as limitations on the scope of any inventions or of what may be claimed, but rather as descriptions of features specific to particular aspect of particular inventions. Certain features that are described in this disclosure in the context of separate aspects can also be implemented in combination in a single aspect. Conversely, various features that are described in the context of a single aspect can also be implemented in multiple aspects separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

Thus, particular aspects of the subject matter have been described. Other aspects are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous. The above description of illustrated implementations of the invention is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an aspect” or “one aspect” or “an implementation” or “one implementation” throughout is not intended to mean the same aspect or implementation unless described as such. Furthermore, the terms “first,” “second,” “third,” “fourth,” etc. as used herein are meant as labels to distinguish among different elements and may not necessarily have an ordinal meaning according to their numerical designation.

In the foregoing description, aspects and aspects of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

What is claimed is:

1. A method comprising:
receiving, at a first digital environment, a request to interact with a first interactive software module, the first interactive software module being integrated with the first digital environment, the request being associated with a number of first virtual tokens required to interact with the first interactive software module;
executing, in response to receiving the request, an instance of the first interactive software module, wherein, based on an outcome determined by the first interactive software module and the number of the first virtual tokens, a number of second virtual tokens are generated, the second virtual tokens being different from the first virtual tokens;
transferring, via an abstraction layer communicatively coupled to the first digital environment and a second digital environment, data indicative of the number of second virtual tokens from the first digital environment to the second digital environment, such that the second virtual tokens are usable with one or more second interactive software modules, the one or more second interactive software modules being integrated with the second digital environment via the abstraction layer; and
providing, in the first digital environment and/or the second digital environment, at least one event handler configured to receive inputs for exchanging one or more second virtual tokens for redeemable objects, each redeemable object being associated with a monetary value.

2. The method of claim 1, wherein the first virtual tokens are stored in a first virtual token container associated with a user and the second virtual tokens are stored in a second virtual token container associated with the user, the second virtual token container being separated from the first virtual token container.

3. The method of claim 2, wherein receiving the request to interact with the first interactive software module comprises updating the first virtual token container to reflect a deduction of the number of first virtual tokens required to interact with the first interactive software module.

4. The method of claim 2, wherein executing the instance of the first interactive software module comprises updating the second virtual token container to reflect a crediting of the number of second virtual tokens to the user based on the outcome determined by the first interactive software module.

5. The method of claim 1, the second virtual tokens are usable to interact with the first interactive software module integrated with the first digital environment.

6. The method of claim 1, wherein executing the instance of the first interactive software module comprises invoking a random number generator, the random number generator being implemented by the first interactive software and configured to generate at least one random value used to determine the outcome generated by the first interactive software module.

7. The method of claim 2, further comprising:
updating, in response to a user-initiated transaction processed by the first digital environment, the first virtual token container and the second virtual token container associated with the user to increase an amount of the first virtual tokens and an amount of the second virtual tokens stored therein, respectively.

8. The method of claim 7, wherein the user-initiated transaction is triggered automatically by the first digital environment upon detecting the first digital environment being accessed by the user.

9. The method of claim 7, wherein the user-initiated transaction is triggered automatically by the first digital environment upon detecting the amount of the first virtual tokens stored in the first virtual token container associated with the user is below a predetermined threshold.

10. The method of claim 7, wherein the user-initiated transaction is triggered by an event corresponding to a limited time availability of increasing the amount of the first virtual tokens and the amount of the second virtual tokens stored in the first virtual token container and the second virtual token container associated with the user.

11. The method of claim 10, further comprising:
receiving data characterizing a plurality of user interactions with the first digital environment;
classifying the user into a user segment, the user segment being selected from a plurality of user segments based on the plurality of user interactions with the first digital environment; and
generating, based on the user segment, the event corresponding to the limited time availability of increasing the amount of the first virtual tokens and the amount of the second virtual tokens stored in the first virtual token container and the second virtual token container associated with the user.

12. The method of claim 11, wherein classifying the user into the user segment comprises:
inputting the data characterizing the plurality of user interactions with the first digital environment into a machine learning model, the machine learning model being trained to output, based on the data characterizing the plurality of user interactions with the first digital environment, the user segment for the generation of the event.

13. The method of claim 10, wherein increasing the amount of the second virtual tokens stored in the second virtual token container associated with the user comprises:
determining a token multiplier corresponding to a tier level designated to the user; and
calculating the amount of the second virtual tokens to increase based on the determined token multiplier.

14. The method of claim 13, further comprising:
updating the tier level upon detecting that the amount of the second virtual tokens stored in the second virtual token container associated with the user during a predetermined time period exceeds a threshold value.

15. The method of claim 1, further comprising:
integrating one or more additional interactive software modules with the first digital environment and/or the second digital environment via the abstraction layer, the abstraction layer being configured to provide a set of provider-specific adapters that implement a plurality of standardized operations for executing one or more instances of the one or more additional interactive software modules in respective digital environment.

16. The method of claim 15, wherein the one or more additional interactive software modules are integrated with the first digital environment and/or the second digital environment without requiring modifications of the respective digital environment, and wherein the one or more instances of the one or more additional interactive software modules are executed via the abstraction layer irrespective of provider-specific operations for executing the one or more instances of the one or more additional software modules.

17. The method of claim 2, further comprising:
presenting to the user, via a first graphical user interface provided by the first digital environment, a visual representation of the first virtual token container associated with the user and a visual representation of the second virtual token container associated with the user; and
presenting to the user, via a second graphical user interface provided by the second digital environment, the visual representation of the second virtual token container associated with the user.

18. The method of claim 17, wherein receiving the request to interact with the first interactive software module comprises:
detecting, via the first graphical user interface, a user selection of a user interface element associated with allocating the number of the first virtual tokens to the execution of the instance of the first interactive software module.

19. A system comprising:
at least one data processor; and
non-transitory memory storing instructions, which, when executed by the at least one data processor causes the at least one data processor to perform operations comprising:
receiving, at a first digital environment, a request to interact with a first interactive software module, the first interactive software module being integrated with the first digital environment, the request being associated with a number of first virtual tokens required to interact with the first interactive software module;
executing, in response to receiving the request, an instance of the first interactive software module, wherein, based on an outcome determined by the first interactive software module and the number of the first virtual tokens, a number of second virtual tokens are generated, the second virtual tokens being different from the first virtual tokens;
transferring, via an abstraction layer communicatively coupled to the first digital environment and a second digital environment, data indicative of the number of second virtual tokens from the first digital environment to the second digital environment, such that the second virtual tokens are usable with one or more second interactive software modules, the one or more second interactive software modules being integrated with the second digital environment via the abstraction layer; and
providing, in the first digital environment and/or the second digital environment, at least one event handler configured to receive inputs for exchanging one or more second virtual tokens for redeemable objects, each redeemable object being associated with a monetary value.

20. A non-transitory computer readable memory storing instructions which, when executed by at least one data processor forming part of at least one computing system, causes the at least one data processor to perform operations comprising:
receiving, at a first digital environment, a request to interact with a first interactive software module, the first interactive software module being integrated with the first digital environment, the request being associated with a number of first virtual tokens required to interact with the first interactive software module;
executing, in response to receiving the request, an instance of the first interactive software module, wherein, based on an outcome determined by the first interactive software module and the number of the first virtual tokens, a number of second virtual tokens are generated, the second virtual tokens being different from the first virtual tokens;
transferring, via an abstraction layer communicatively coupled to the first digital environment and a second digital environment, data indicative of the number of second virtual tokens from the first digital environment to the second digital environment, such that the second virtual tokens are usable with one or more second interactive software modules, the one or more second interactive software modules being integrated with the second digital environment via the abstraction layer; and
providing, in the first digital environment and/or the second digital environment, at least one event handler configured to receive inputs for exchanging one or more second virtual tokens for redeemable objects, each redeemable object being associated with a monetary value.
